(19) United States
(12) Patent Application Publication
(10) Pub. No.: US 2007/0169154 A1
(43) Pub. Date: Jul. 19, 2007

(54) Internet video player

(75) Inventor: Juen-Tien Peng, Chung Li (TW)

Correspondence Address: HDSL, 4331 STEVENS BATTLE LANE, FAIRFAX, VA, 22033, US

(73) Assignee: Action Electronics Co., Ltd.

(21) Appl. No.: 11/331,209

(22) Filed: Jan. 13, 2006

(51) Int. Cl. H04N 7/173; H04N 7/16; H04N 7/18

(52) U.S. Cl. 725/81; 725/110; 725/112; 725/134; 725/133; 725/141; 725/111

(57) ABSTRACT

An internet video player, having a built-in DVD reader to access a video content and a central processing unit to perform image decode thereon, so as to display the image of such video information and transmit the image to a receiving end through internet. Therefore, the video content of read by the DVD reader can also be played at the receiving end. The video can also be connected to an internet phone to switch the play mode into a network telephone mode by executing an internal application program. An audio communicate can thus be established through the internet. The video player is easy to operate such that a person without the knowledge of operating a computer can also easily access.

### BACKGROUND OF THE INVENTION

1. Field of Invention

The present invention relates in general to a video player, and more particular, to an internet connectible and accessible video player.

2. Related Art

As the advancement of the information technology, storage of audio/video files has been evolved from tape, VCD to DVD with larger and larger capacity. The display method is also improved from connecting the video player with television to using a personal computer or laptop computer. Recently, an audio/video player with a portable size compatible with a notebook computer has been developed, such that the user can watch the VCD or DVD at any time, any place.

Compared to the notebook computer, the portable audio/video player also has a flappable screen. However, the functions between the portable audio/video player and the computer are different. Apart from displaying the recorded content of a disk on the screen, the audio/video is also inoperative to compute, edit and access internet like the computer. This is because this type of audio/video player is not equipped with a keyboard allowing the user to perform complex input. On the other hand, although the computer provides power function for versatile tasks, the user requires certain level of knowledge for operation. In contrast, the audio/video player includes only a few buttons or keys to achieve the display, pause and similar operations. Therefore, if the audio/video player is accessible from internet or network phone, such that a person without the knowledge of using computer can also easily use the computer.

### SUMMARY OF THE INVENTION

An internet accessible video player operative to play video saved in a CD, VCD or DVD on a display screen is provided. The video player is operative to perform peer-to-peer transmission of data, video or files saved in a disk by connecting to a wired or wireless network card by a network interface card.

The video player as provided can also be connected to an external internet or network telephone, such that the user can communicate with another party through internet by using a network interface card connected thereto.

During the internet telephone conversation, the video player is also operative to perform peer-to-peer transmission to transmit the video played on the display to the other party.

Accordingly, the internet video player of the present invention includes a central processing unit, a memory device, at least on network card, at least on expansion card, a display screen and a DVD reader. The central processing unit is to control operation of the internet video player. The memory device is connected to the central processing unit, the memory device storing an application program therein. The network card is connected to the central processing unit to connect internet. The expansion card is connected to the central processing unit to connect an external device. The display screen is connected to the central processing unit for image or video display. The DVD reader is controlled by the central processing unit to read video information saved in a storage device and to play the video information on the display screen. Therefore, the video player is operative to perform peer-to-peer transmission to connect to the external internet or network telephone, so that the user can communicate with another party through internet by using a network interface card.

### BRIEF DESCRIPTION OF THE DRAWINGS

The present invention will become more fully understood from the detailed description given hereinbelow illustration only, and thus are not limitative of the present invention, and wherein:

FIG. 1 shows a block diagram of an internet accessible and connectible video player; and

FIG. 2 is a block diagram showing the operation of the video player.

### DETAILED DESCRIPTION OF THE INVENTION

The internet video player includes a portable video player allowing the user to retrieve and play video stored in a disk. By using a wired or wireless network card to connect an external network phone, an audio communication can also be established.

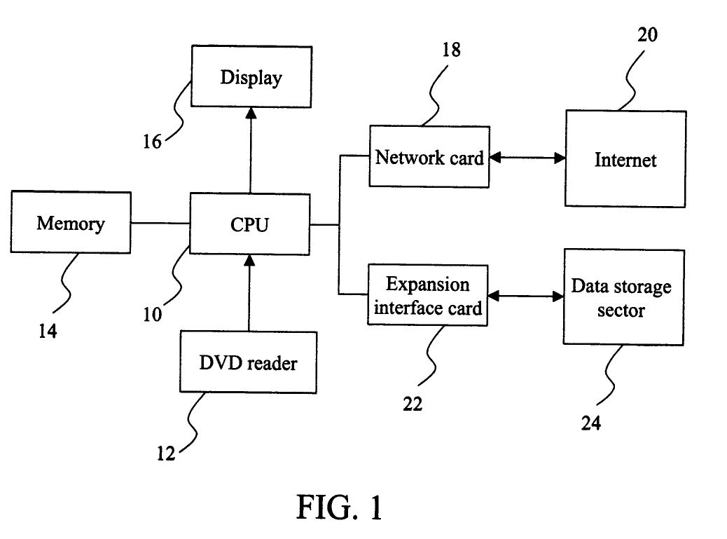

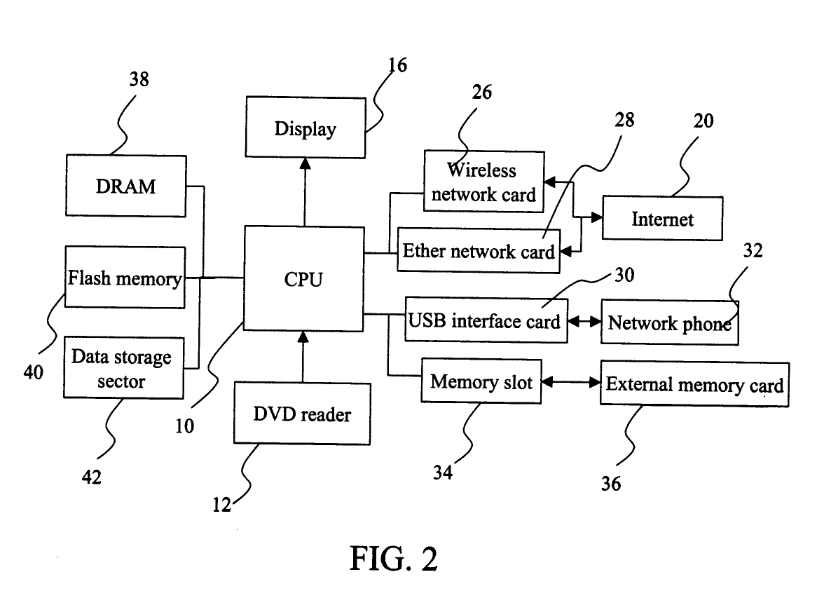

Referring to FIGS. 1 and 2, the video player includes a central processing unit 10 to control the operation of internal devices of the video player, a memory 14 connected to the central processing unit 10, a network card 18, an expansion interface card 22, a display screen 16, and a DVD reader 12. The memory 14 may includes a dynamic random access memory (RAM) 38, a flash memory 40 and a data storage sector 42. The RAM 38 is used for temporary data storage, the flash memory includes built-in application programs, while the data storage sector 42 is used to store data. The network interface card 18 includes a wireless network card 26, an ether network card 28 to connect the central processing unit 10 to connect to internet 20 in a wired or wireless way. The expansion interface card 22 is connected to the central processing unit to connect a plurality of external devices 24. The display screen 16 may include a liquid crystal display for display image. The DVD reader 12 is controlled by the central processing unit 10 to read image or video data stored in a disk. The data read by the DVD reader 12 is temporary stored in the RAM 38 of the memory 14. By executing the application programs saved in the flash memory 40, the image is displayed on the display screen 16. The DVD reader 12 is operative to receive and read information from storage device such as CD, VCD and DVD disk.

The expansion interface card 22 includes a USB interface card 30 to connect the external devices 24 having USB connector such as a network phone 32. The expansion interface card 22 can also be a memory slot 34 to connect an external memory card 36 such as SD or CF memory card.

When the data saved in the disk or memory card 36 is read by the DVD reader 12 and temporarily stored in the RAM 38, the application programs stored in the flash memory 40 is executed, and data is then decoded by the central processing unit 10. The decoded data is then displayed by the display screen 16 and/or saved in the data storage sector 42. When the USB interface card 30 is hooked up to a network phone 32, the user can establish an internet telephone conversation by connecting the internet. The user can also perform peer-to-peer transmission of the currently displayed data during the telephone conversation. Therefore, the user at the other side of the telephone line can also watch the data at the same time.

The video player as described above does not provide computation and word processing functions. In contrast, the video player requires very simple functional keys allowing the user to play, stop, fast forward, rewind and pause the video. Therefore, the user does not need to proper typing skill to operate the video player. In addition to play video and establish internet phone conversation, the central processing unit can also receive digital or analog signal television signal or broadcast signal and perform image decode to display the image or video on the display screen. Further, the video player does not operate under window operation system that is prone to virus by data transmission.

Being connectible to external devices, the internet video player can perform network phone conversation to reduce the expense by regular phone call. The peer-to-peer transmission of audio information, text and file is much less vulnerable to virus typically affect operation of computer. The compact volume provides the portability of the video player, which is thus practical and convenient to use.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An internet video player, comprising:
a central processing unit to control operation of the internet video player,
a memory device connected to the central processing unit, the memory device storing an application program therein;
at least one network card connected to the central processing unit to connect internet;
at least one expansion card connected to the central processing unit to connect an external device;
a display screen connected to the central processing unit for image or video display; and
a DVD reader being controlled by the central processing unit to read video information saved in a storage device and to play the video information on the display screen.

2. The video player of claim 1, wherein the display screen includes a liquid crystal display.

3. The video player of claim 1, wherein the storage device includes a CD, a VCD or a DVD.

4. The video player of claim 1, wherein the network card includes a wireless network card or an Ethernet card to connect the internet through wire or wireless communication.

5. The video player of claim 1, wherein the expansion card includes a USB card to connect the external device with a USB connector.

6. The video player of claim 1, wherein the expansion card includes a memory slot for reading a SD or CF card.

7. The video player of claim 1, wherein the central processing unit is operative to receive a digital or analog television signal and to decode and display an image carried by the signal.

8. The video player of claim 1, wherein the memory device includes:
a dynamic random access memory for temporarily save data accessed by the central processing unit;
a flash memory for saving the application program; and
a data storage sector for data storage.

9. The video player of claim 1, further comprising a plurality of functional keys to switch operation of the application program saved in the memory device.

10. The video player of claim 1, wherein the external device includes a network phone to establish internet audio communication.
